(19) United States
(12) Patent Application Publication
(10) Pub. No.: US 2008/0025195 A1
(43) Pub. Date: Jan. 31, 2008

(54) OFDM SYSTEM ADAPTED TO MULTI-PROGRAM TRANSMISSION THEREFORE

(75) Inventors: Haiyun Yang, San Jose, CA (US); Dinesh Venkatachalam, Fremont, CA (US)

Correspondence Address: FRANKLIN (LIN) YANG, 91 CANTERBURY GATE, LYNBROOK, NY, 11563, US

(73) Assignee: LEGEND SILICON, Fremont, CA (US)

(21) Appl. No.: 11/550,400

(22) Filed: Oct. 17, 2006

Related U.S. Application Data
(60) Provisional application No. 60/820,319, filed on Jul. 25, 2006.
(60) Provisional application No. 60/820,316, filed on Jul. 25, 2006.

(51) Int. Cl. H04J 11/00

(52) U.S. Cl. 370/203

(57) ABSTRACT

An OFDM (Orthogonal frequency-division multiplexing) communication system is provided. The system includes at least two programs being simultaneously transmitted under one spectrum. Each program is respectively modulated under a different or similar scheme. Each of the at least two programs commonly share a control frame. The control frame is transmitted under a similar or more robust modulation scheme than the at least two programs' modulations respectively.

### REFERENCE TO RELATED APPLICATIONS

This application claims an invention which was disclosed in Provisional Application No. 60/820,316, filed Jul. 25, 2006 entitled “Modulator for an LDPC based TDS-OFDM Communication System”. The benefit under 35 USC §119(e) of the United States provisional application is hereby claimed, and the aforementioned application is hereby incorporated herein by reference.

### FIELD OF THE INVENTION

The present invention relates generally to communication systems or devices. More specifically, the present invention relates to novel communication systems or devices associated with an OFDM (Orthogonal frequency-division multiplexing) device.

### BACKGROUND

OFDM (Orthogonal frequency-division multiplexing) is known. U.S. Pat. No. 3,488,445 to Chang describes an apparatus and method for frequency multiplexing of a plurality of data signals simultaneously on a plurality of mutually orthogonal carrier waves such that overlapping, but band-limited, frequency spectra are produced without casing interchannel and intersymbol interference. Amplitude and phase characteristics of narrow-band filters are specified for each channel in terms of their symmetries alone. The same signal protection against channel noise is provided as though the signals in each channel were transmitted through an independent medium and intersymbol interference were eliminated by reducing the data rate. As the number of channels is increased, the overall data rate approaches the theoretical maximum.

The time domain synchronous-orthogonal frequency division multiplexing (TDS-OFDM) system has been obtained a lot attention recently. It also becomes the core technology in the China digital television terrestrial transmission standard. In TDS-OFDM system, signals are grouped into a series of hierarchical frames. The most basic element is the frame. In a frame there are 3744 symbols that carry the data and 36 symbols that carry the Transmission Parameter Signaling (TPS). The TPS carries information for the demodulator to automatically adapt to the incoming transmission such as: FEC inner code rate, time interleaver length, etc.

Referring to FIG. 1, a signal frame consists of a frame and a guard interval. The guard interval length may either be the frame length divided by 9 or the frame length divided by 4. For sake of simplicity, a signal frame is referred to as frame hereinafter. For the above signal frame, it can be further characterized into another five layers. From bottom up, they are group layer, super-frame layer, mega-frame layer, minute-frame layer and day-frame layer. Table 1 list the duration of each unit and their inter-relationship for transmission frames or schemes PN420 and PN945.

TABLE 1
Data Frame Structure in TDS-OFDM System

| Units | PN420 | PN945 |
|---|---|---|
| signal frame | 555.56 us | 625 us |
| Group | four frames | four frames (except |
| | | last group) |
| super-frame | 225 frames (125 ms) | 200 frame (125 ms) |

| | |
|---|---|
| mega-frame | 8 super-frame (1 sec) |
| minute-frame | 60 mega-frame (1 min) |
| day-frame | 1440 minute-frame (1 day) |

As can be seen, for PN420, each super-frame consists of 225 frames; for PN945, each super-frame consists of 220 frames. In each frame, the guard interval portion is always modulated using QPSK (quadriphase Phase-shift keying), in which the signal frame can be modulated by QPSK, 16QAM, or 64QAM. The modulation for all signal frames should be of the same type. When multiple programs are transmitted, a known method 1 as shown in FIG. 1, is using multiplexer 2 to multiplex multiple information steams or programs P₁, P₂, . . . P_{N} into one transport stream (TS) first for transmission by transmitter 4, and then modulated the resultant TS as a whole and feed same into the TDS-OFDM transmitter 4. The disadvantage of this simple scheme of FIG. 2 is that all TS packets will be enclosed and modulated in the same or identical way. When the programs need to be received at different reception conditions, this simple scheme cannot achieve this purpose. The other disadvantage is that the time slice concept cannot exist on the physical layer.

As can be seen a novel OFDM communications system for frame transmission adapted to transmit a control sub-frame within the frame, and suitable for transmitting at least two programs with different modulation rates is needed.

### SUMMARY OF THE INVENTION

In an OFDM communications system, wherein the system is adapted to transmit at least two distinct streams within one spectrum with the two streams are orthogonal in the time domain.

In an OFDM communications system, a novel scheme suitable for supporting different applications in a single spectrum is provided.

In an OFDM communications system, a novel scheme, which is referred as TDS-OFDM terrestrial and handheld (hereinafter referred to as TDS-OFDM-TH), is described in the present invention. In the TDS-OFDM-TH system, the first frame (frame 0) in each super-frame is referred as control frame. All the others are referred as data frame. Starting from frame 1 (i.e. 1^{st} data frame), each group of four consecutive frames is referred as a group.

In an OFDM communications system, wherein the system is adapted to transmit at least two distinct streams within one spectrum with the two streams are orthogonal in the time domain. The two streams can be encoded and modulated differently.

In an OFDM communications system, at least one application can be a terrestrial program modulated at a higher-order constellation and at least one wireless mobile program suitable for a lower-order constellation.

In an OFDM communications system, wherein the control frame is modulated at the lowest order constellation relative to the modulation of the terrestrial program and the wireless mobile program.

In an OFDM communications system, an average data rate can be computed based upon the total number of groups.

In an OFDM communications system, power saving devices and methods are provided for a receiving device during non-transmission to the device, because of the robust a control packet received during a transmission.

In an OFDM communications system, power saving devices and methods are provided using information contained within the control frame.

In an OFDM communications system, power saving devices and methods are provided such that a mobile device receiving the H-program may shut its power down at least one level when the mobile device is not receiving program signals.

An OFDM (Orthogonal frequency-division multiplexing) communication system is provided. The system includes at least two programs being simultaneously transmitted under one spectrum. Each program is respectively modulated under a different or similar scheme. Each of the at least two programs commonly share a control frame. The control frame is transmitted under a similar or more robust modulation scheme than the at least two programs' modulations respectively.

In an OFDM (Orthogonal frequency-division multiplexing) communication system, a method is provided. The method comprises the steps of: providing at least two programs being simultaneously transmitted under one spectrum with each program being respectively modulated under a different or similar scheme; and for each of the at least two programs, sharing commonly a control frame with the control frame transmitted under a similar or more robust modulation scheme than the at least two programs' modulations respectively.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a prior art example of a signal frame consists of a frame and a guard interval.

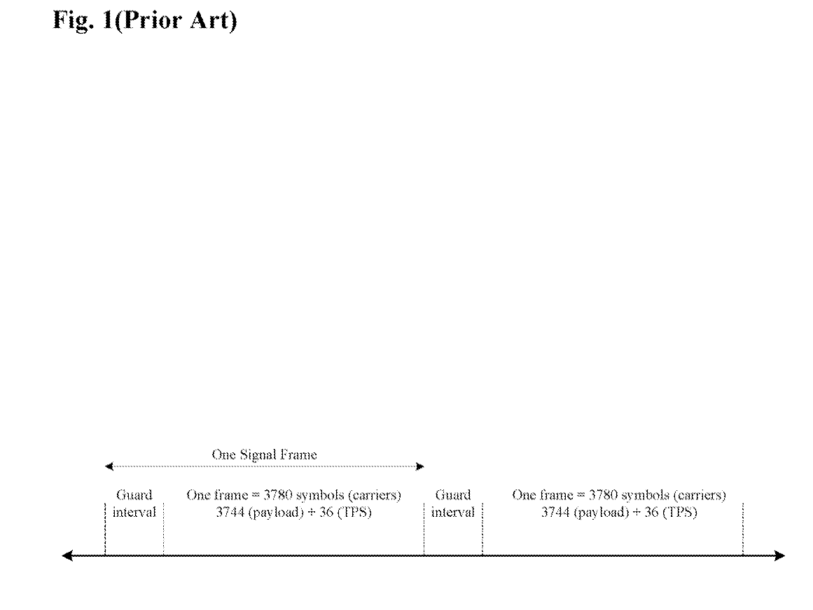

FIG. 2 is an example of known prior art communications system.

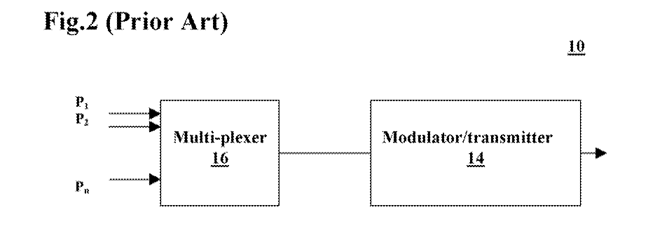

FIG. 3 is an example of a signal frame subdivided into groups.

FIG. 4 is an example of a first multiplex device for both IP stream and T stream of the present invention.

FIG. 5 is a second example of a second multiplex device for both T stream and a DVB (digital video broadcast) compatible stream of the present invention, and

FIG. 6 is a third example of a third multiplex device for both DVB (digital video broadcast) compatible streams and IP streams of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a novel OFDM communications system for frame transmission adapted to transmit a control sub-frame within the frame, and suitable for transmitting at least two programs with different modulation rates. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a novel OFDM communications system for frame transmission adapted to transmit a control sub-frame within the frame, and suitable for transmitting at least two programs with different modulation rates described herein. The non-processor circuits may include, but are not limited to, a radio receiver, a radio transmitter, signal drivers, clock circuits, power source circuits, and user input devices. As such, these functions may be interpreted as steps of a method to perform within a novel OFDM communications system for frame transmission adapted to transmit a control sub-frame within the frame, and suitable for transmitting at least two programs with different modulation rates. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

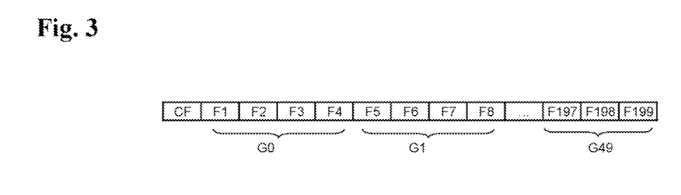

A complete novel scheme, referred as TDS-OFDM terrestrial and handheld (hereinafter referred to as TDS-OFDM-TH), is described in the present invention. In the TDS-OFDM-TH system, the first frame (frame 0) in each super-frame is referred as control frame. The others are referred as data frames. Starting from frame 1 (i.e. 1^{st} data frame), each group of four consecutive frames is referred as one or a single group. For PN420, there are a total of 56 groups, from group 0 to group 55. Similarly, as shown in FIG. 3 for PN945 there are a total of 50 groups. However, for PN945, the last group has only 3 frames, as shown in FIG. 3. The control frame is always modulated in the relatively robust QPSK having the lowest FEC rate such as FEC 0.4, therefore even if some of the data frames are not transmitted or modulated as desired, at least their respective location can be decoded because of the usage of the robust QPSK mode. The other groups are split into two programs, T-program and H-program. An exemplified T-program may be the territorial high-definition digital TV program suitable for a fixed location receiver. Whereas, an exemplified H-program may be a mobile program suitable to be received by a PDA (personal digital assistant) or a cell phone. The modulation and the FEC rate in each program is independent, that is to say that the groups for T-program can be modulated using 64QAM, while the groups for H-program can be modulated using QPSK.

As can be seen, the present invention provides new scheme, which is suitable for supporting different applications in one or a single spectrum. For example, a T-program, modulated at higher QAM, can be used to transmit high density (HD) program for static receivers; and on the other hand, H-program, modulated at lower QAM, such as QPSK, can be used to transmit multiple low data rate programs for handheld receivers.

Control frame is always modulated using a fixed robust scheme such as with QPSK with FEC (forward error correction) 0.4 without any interleaving. For example, even if the rest of the signal frames are being sent in 16QAM or 64QAM, the control frame is still modulated with QPSK with FEC 0.4. Each control frame consists of two 188-byte MPEG-2 packets with PID 0×0017. The first packet in a control frame is reserved for MIP (Megaframe Initialisation Packets) packet. As can be seen, in prior art systems wherein MIP packets are required to be transmitted in the single frequency networks, they are always transmitted using the first packet in a control frame. The second packet is used to transmit all necessary information for providing simultaneous transmission or modulation for both terrestrial and handheld services. The information in this packet is defined in Table 2.

TABLE 2
second Packet in Control Frame

| | No of | |
|---|---|---|
| Syntax | bits | Mnemonic |
| control_frame_packet_2( ) { | | |
| sync_byte | 8 | bslbf |
| transport_error_indicator | 1 | bslbf |
| payload_unit_start_indicator | 1 | bslbf |
| transport_priority | 1 | bslbf |
| PID | 13 | bslbf |
| transport_scrambling_control | 2 | bslbf |
| Adaptation_field_control | 2 | bslbf |
| Continuity_counter | 4 | bslbf |
| T_inflv | 2 | bslbf |
| T_rate | 2 | bslbf |
| T_mode | 2 | bslbf |
| reserved_bit | 2 | bslbf |
| PN_mode | 2 | bslbf |
| H_rate | 2 | bslbf |
| H_mode | 2 | bslbf |
| reserved_bit | 10 | bslbf |
| if PN420 | | |
| group_allocation_information | 56 | bslbf |
| else if PN945 | | |
| group_allocation_information | 50 | bslbf |
| reserved_bit | 6 | |
| end | | |
| reserved_bit | 5 | bslbf |
| super_frame_no | 3 | uimsbf |
| reserved_bit | 2 | bslbf |
| H_num_prog | 6 | uimsbf |
| for (i=0; i<H_num_prog; i++) { | | |
| reserved_bit | 1 | bslbf |
| flag_DVB | 1 | bslbf |
| starting_group_no | 6 | uimsbf |
| } | | |
| for (i=H_num_prog; i<63; i++) { | | |
| reserved_bit | 8 | bslbf |
| } | | |
| reserved_bit | 8 | bslbf |
| for (i=0; i<H_num_prog; i++) { | | |
| flag_alias_with_prev_group | 1 | bslbf |
| nxt_appear_supfrm_no | 3 | bslbf |
| } | | |
| for (i=H_num_prog; i<63; i++) { | | |
| reserved_bit | 4 | bslbf |
| } | | |
| reserved_bit | 4 | bslbf |
| num_pkg_per_supfrm | 16 | uimsbf |
| for (i=0; i<75; i++) { | | |
| reserved_bit | 8 | bslbf |
| } | | |
| } | | |

In Table 2, bslbf stands for bit string, left bit first. uimsbf stands for unsigned integer, most significant bit first. This section describes each field listed in Table 2. The first eight fields are respectively,
1. sync_byte,
2. transport_error_indicator,
3. payload_unit_start_indicator,
4. transport_priority,
5. PID,
6. transport_scrambling_control,
7. adaptation_field_control and
8. continuity_counter
   the first eight fields comply with ISO/IEC 13838-1 clause 2.4.3.2. The payload_unit_start_indicator is not used for TDS-OFDM-TH, and shall be set to 1. PID—It is a fixed to 0×0017. transport_priority is not used for TDS-OFDM-TH, and shall be set to 1. transport_scrambling_control is not used for TDS-OFDM-TH, and shall be set to 00 (not scrambled). adaptation_field_control shall be set to 01 (payload only). T_intlv—This 2-bit field indicate the time-interleaver mode for terrestrial service as listed in Table 3.

TABLE 3
Time-interleaver Mode

| Value | Description |
|---|---|
| 00 | no time-interleaver |
| 01 | B = 52 M = 48 |
| 10 | B = 52 M = 240 |
| 11 | B = 52 M = 720 |

T_mod is 2-bit field indicates the modulation for terrestrial service as listed in Table 4.

TABLE 4
Modulation Mode

| Value | Description |
|---|---|
| 00 | 4QAM |
| 01 | 16QAM |
| 10 | 64QAM |
| 11 | reserved |

T_rate is 2-bit field indicative of the FEC encoding for terrestrial service as listed in Table 5.

TABLE 5
FEC Encoding Rate

| Value | Description |
|---|---|
| 00 | LDPC (7488, 3008) (r = 0.4) |
| 01 | LDPC (7488, 4512) (r = 0.6) |
| 10 | LDPC (7488, 6016) (r = 0.8) |
| 11 | reserved |

PN_mode—This 2-bit field indicate the PN mode as given in Table 6.

TABLE 6
PN Mode

| Value | Description |
|---|---|
| 00 | PN420 |
| 01 | PN945 |
| 10 | reserved |
| 11 | reserved |

H_rate is a 2-bit field indicative of the FEC encoding rate for handheld service as listed in Table 5. H_mod is a 2-bit field indicative of the modulation for handheld service as listed in Table 4. super_frame_no is 3-bit field unsigned integer indicate the current super-frame number. H_num_prog is 6-bit field is an unsigned integer. It indicates the total number of programs for handheld service, referred as H-program. H_num_prog is not used to indicate the number of H-program in the current super-frame. For example, the number H-program carried in the current super-frame is 4, but the total number of H-programs in eight super-frames (or one mega-frame) is 16. H_num_prog should be set to 16. When H_num_prog is 0, there is no H-program service, and all groups are allocated for T-program. The maximum number of H-program is 63.

group_allocation_information—For PN420, each bit in this 56-bit field is corresponding one group for PN420. For PN945, this field has 50 bits. The most left bit is for Group 0. When this bit is 0, the corresponding group is allocated to terrestrial service, referred as T-program. When it is 1, the corresponding group is allocated to handheld services.

For each H-program, there are 4 fields. They are flag_DVB, starting_group_no, flag_alias_with_prev_group, and next_appear_supfrm_no. flag_DVB is a 1-bit flag and used to indicate the input stream for H-program. The other three fields indicate the location of each H-program among the groups for H-program. The details are following:

flag_DVB is a bit flag. When it is 0, it indicates that the current H-program is for IP stream. So the input stream will be encapsulated using DMB-IP packet (to be described in the next section). When flag_DVB is 1, the input stream is obtained by de-multiplexing a DVB stream with multiple H-programs. In this case, after de-multiplexing the DVB stream, the stream for each H-program will be transmitted without any encapsulation.

starting_group_no is a 6-bit field indicative of the starting group number for the given H-program. When a H-program is not transmitted in the current super-frame, starting_group_no of this H-program should be set to 63.

flag_alias_with_prev_group is a bit flag. It is used to indicate whether the current H-program, Hᵢ, and next H-program, Hᵢ₊₁, share the first group for Hᵢ₊₁, which is referred as starting_group_no[i+1]. When it is 1, the packets of Group starting_group_no[i+1]are not only for Hᵢ₊₁ but also for Hᵢ. In other words, the first a few packets in that group belong to Hᵢ, the rest packets belong to Hᵢ₊₁. When it is 0, all packets in that group belong to Hᵢ₊₁. For example, if starting_group_no for the 3^{rd} H-program=20; flag_alias_with_prev_group for the 3^{rd} H-program=0; starting_group_no for the 4^{th} H-program=23; then it is an indication that Group 23 only consists of packets for the 4^{th} H-program. That is to say the packets for the 3^{rd} H-program is from Group 20 to Group 22. In yet another example, if these fields change to starting_group_no for the 3^{rd} H-program=20; flag_alias_with_prev_group for the 3^{rd} H-program=1; starting_group_no for the 4^{th} H-program=23; some packets in Group 23 are for the 3^{rd} H-program and some are for the 4^{th} H-program. Then it is possible that the first three frames in Group 23 belong to the 3^{rd} H-program and the last frame in this group is for the 4^{th} H-program. It is also possible that the first two frames and the first two packets in the 3^{rd} frame (say there are 6 packets in one frame) belong to the 3^{rd} H-program, the rest four packets in the 3^{rd} frame and last frame belong to the 4^{th} H-program. In yet a 3^{rd} example, if the fields are values as starting_group_no for the 3^{rd} H-program=20; flag_alias_with_prev_group for the 3^{rd} H-program=1; starting_group_no for the 4^{th} H-program=23; flag_alias_with_prev_group for the 4^{th} H-program=1; starting_group_no for the 5^{th} H-program=23; then it could be due to the following scenario (still assuming 6 packets in one frame). Therefore, the first four packets in the 1^{st} frame of Group 23 are associated with 3^{rd} H-program, and the rest two packets in the 1^{st} frame, and the 2^{nd} frame and 3^{rd} frame in Group 23 are associated with 4^{th} H-program; as well as the 4^{th} frame in Group 23 is associated with 5^{th} H-program.

In the above examples, the determination of which H-program a packet belongs to is indicated by the H_prog_id in the TDS-OFDM-TH packet, which will be described later.

nxt_appear_supfrm_no is a 3-bit field indicative of the next super-frame which carries the given H-program. When nxt_appear_supfrm_no is zero, it indicates that there are no more super-frames in the current mega-frame, which carry the given H-program.

Let's assume that the eight super-frames in one mega-frame are referred to as SF0, SF1, . . . , SF7 respectively. If nxt_appear_supfrm_no[SF0]=1, it means that SF1 has the groups for the given H-program; if nxt_appear_supfrm_no[SF0]=4, it means that the next super-frame with the given H-program is SF4. That is to say SF1, SF2 and SF3 don't have any groups for the given H-program.

If one H-program is transmitted in every super-frame of a mega-frame, nxt_appear_supfrm_no for the eight super-frames should be set to 1, 2, 3, 4, 5, 6, 7, 0; if an H-program is transmitted only at one super-frame (say SF4) in each mega-frame, nxt_appear_supfrm_no for SF0 to SF7 of this H-program should be set to 4, 4, 4, 4, 0, 0, 0, 0; if another H-program is transmitted at three super-frames (say SF0, SF4 and SF6) in each mega-frame, nxt_appear_supfrm_no for SF0 to SF7 of this H-program should be set to 4, 4, 4, 4, 6, 6, 0, 0. In case of all groups are allocated for T-program, starting_group_no, flag_alias_with_prev_group and nxt_appear_supfrm_no shall be set to 0.

num_pkg_per_supfrm is a 16-bit unsigned number. It is used to indicate the number of packets in each super-frame. num_pkg_per_supfrm can be computed based on t_rate, t_mode, h_rate, h_rate and grp_alloc_info.

The description infra is related to Handheld Services for IP Stream and DVB (digital video broadcast) Compatible Streams. As can be seen, for terrestrial service, each MPEG-TS packet in the input TS stream is transmitted directly without any processing. While for handheld service, the input stream could be IP streams or a DVB compatible stream. The parameter, flag_DVB, in the control frame is used for this indication. When flag_DVB is 0, the current H-program is used to carry an IP stream. In this case, the input IP stream needs to be encapsulated into DMB-IP packet. When flag_DVB is 1, the current H-program is used to carry packets obtained by de-multiplexing a DVB compatible stream with multiple H-program.

When the input stream is an IP stream, the input data is encapsulated into DMB-IP packet. For each group of 184 data bytes, another 4-byte is added to construct a DMB-IP packet with totally 188-byte, as shown in Table 7:

TABLE 7
Encapsulation of DMB-IP for IP Stream

| | No of | |
|---|---|---|
| Syntax | bits | Mnemonic |
| DMB_IP_packet( ) { | | |
| sync_byte | 8 | Bslbf |
| transport_error_indicator | 1 | Bslbf |
| payload_unit_start_indicator | 1 | Bslbf |
| transport_priority | 1 | Bslbf |
| PID | 13 | Bslbf |
| reserved_bit | 2 | Bslbf |
| H_prog_id | 6 | Uimsbf |
| for (i = 0; i < 184; i++) { | | |
| data_byte | 8 | Bslbf |
| } | | |
| } | | |

The first five fields, sync_byte, transport_error_indicator, payload_unit_start_indicator, transport_priority and PID, comply with ISO/IEC 13838-1 clause 2.4.3.2, Table 2 and Table 3. payload_unit_start_indicator is not used, and shall be set to 1. PID is fixed to 0×0018. transport_priority is not used, and shall be set to 1. H_prog_id is a 6-bit field that is indicative of which H-program the payload belongs to. The value of H_prog_id is 0 to 62. When H_prog_id=0, the payload belongs to the 1^{st} H-program. When H_prog_id=62, the payload belongs to the last H-program. The status of H_prog_id=63 is reserved.

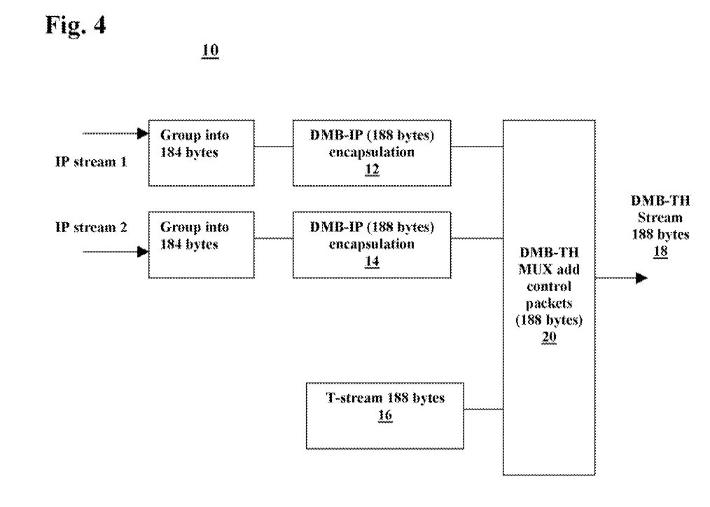

Referring to FIG. 4, in the TDS-OFDM-TH system, the Multiplexing for T-stream and IP-stream 10 are as follows. When the input streams have multiple IP streams such as IP stream 1 and IP stream 2, each IP stream is encapsulated into a series of DMB-IP packets respectively. In other words, IP stream 1 is encapsulated encapsulater 12; and IP stream 2 is encapsulated encapsulater 14. The DBM-IP packets from each IP stream and T-stream 16 (for the terrestrial TV program) are multiplexed into a TDS-OFDM-TH stream 18 by multiplexer 20. The control packets are programmed and inserted into the TDS-OFDM-TH stream at multiplexer 20. This process or device is know as TDS-OFDM-TH Multiplex for IP Stream and T-stream. In the TDS-OFDM-TH stream, all packets from T-stream and H-stream must be loaded to the frames specified by the 2^{nd} control packet.

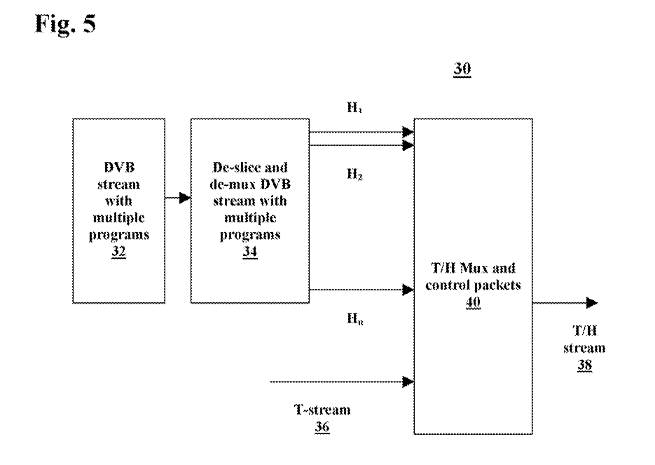

Referring to FIG. 5, in the TDS-OFDM-TH system, the Multiplexing for T-stream and DVB Compatible Stream 30 are depicted as follows. When the input stream is a DVB data broadcast stream with multiple programs 32, and this stream is encapsulated with an encapsulating scheme such as MPE-FEC, the multiple program stream is de-multiplexed into a few individual streams (H1, H2, . . . ) based on the time-slice information embedded in the original stream. After de-multiplexing, each H stream is a self-contained stream for one program. The original information such as MPE-FEC is still reserved for each H stream. All H streams and a T-stream 36 are multiplexed into a TDS-OFDM-TH stream 38 by Multiplexer 40 with the control packets being programmed and inserted into the stream therein. This process or device 30 is known as TDS-OFDM-TH Multiplexing for T-stream and DVB Compatible Stream.

In the TDS-OFDM-TH stream 38, all packets from T-stream and H-stream must be loaded to the frames specified by the 2^{nd} control packet. In this case, flag_DVB is set to “1” for each H program, and all packets for this H program are loaded into corresponding frames and transmitted directly.

In a more complicated scenario, IP streams and DVB compatible streams could exist in one super-frame. As far as the corresponding flag_DVB is set correctly, a TDS-OFDM-TH stream can include packets from both IP streams and a DVB compatible stream.

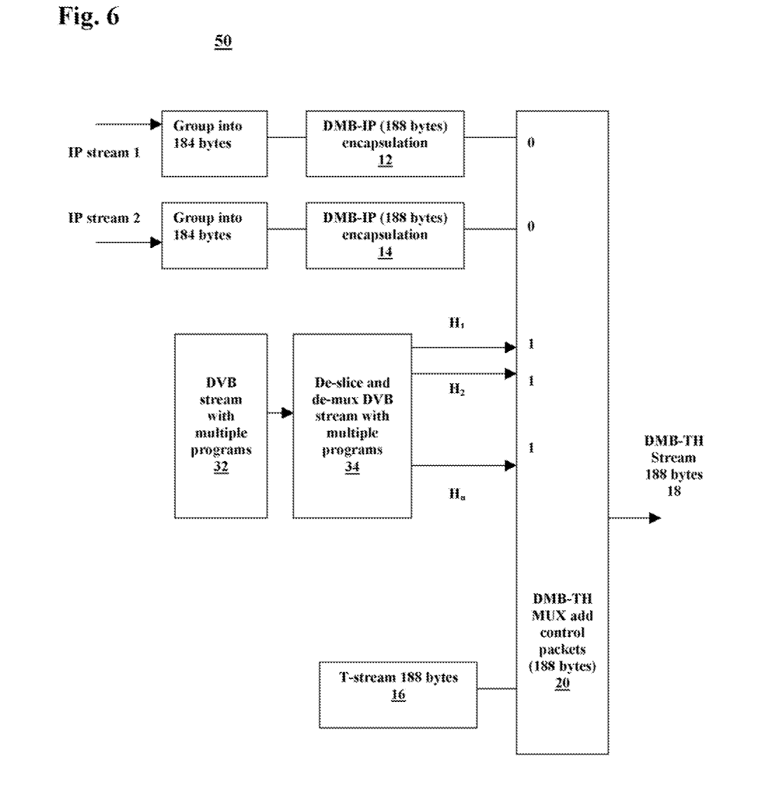

Referring to FIG. 6, a third example 50 of a third multiplex device for both DVB (digital video broadcast) compatible streams and IP streams of the present invention is depicted. As can be seen, third example 50 can be considered as a combination of FIGS. 4-5. The binary numerical setting in multiplexer 40 is defined by the predetermined values of flag_DVB.

The present invention contemplates simultaneous Terrestrial and Handheld Services. Terrestrial service and handheld service are broadcasted in the same spectrum. As such, the transmission equipment needs to obey following rules. For Modulation Mode, FEC rate and Time-interleaver, control frame always uses QPSK such as QPSK LDPC (7488, 3008). The modulation and FEC rate for T-program and H-program can be different. Time-interleaver (when used) is only applied to T-program. All H-programs have the same modulation mode and FEC rate. For Packet ID (PID), the packets for T-program keep their original PID. For H-program, if it is a DVB compatible streams, all packets also keep their original PID. If it is an IP stream, after encapsulation, all packets have a special PID (0×0018). With regard to Program Clock Reference (PCR), the PCR of T-program must be adjusted. The PCR of H-program for DVB compatible streams also needs to be adjusted. While for an IP stream in H-program, it doesn't have any PCR. With regard to how to Compute Average Data Rate at Input of Modulator, since the T-program and H-program can have different modulation and FEC rate, the average data rate at the input of modulator depends on both the modulation/FEC rate and the group allocation. Table 8 gives the number of packets each frame can carry.

TABLE 8
Number of Packets in One Frame

| fec_rate | 00 (rate = 0.4) | 01 (rate = 0.6) | 10 (rate = 0.8) |
|---|---|---|---|
| QPSK | 2 | 4 | 6 |
| 16QAM | 4 | 6 | 8 |
| 64QAM | 6 | 9 | 12 |

Based on this table and the number of groups for T-program and H-program, the average data rate can be computed. The following example shows how to compute this rate.

Example: for PN420, 30 groups are allocated to T-program, and the other 26 groups are for H-program. T-program is 64QAM rate=0.6, H-program is QPSK rate=0.4. The total number of packets in one super-frame is
control frame: 1 frame×2packet/frame=2 packets
T-program: 30 groups*4 frames/group*9 packet/frame=1080 packets
H-program: 26 groups*4 frames/group*2 packet/frame=208 packets
Total packets: 2+1080+208=1290 packets

$$The average data rate is \frac{1290 * 188 * 8 bits}{125 ms} = 15 \text{,} 521 \text{,} 280 bps .$$

With regard to strategy on Bit Stream MUX, in order to achieve the best power saving, it is strongly suggested that the transmitter equipment follow these guidelines: A super-frame always starts with groups for T-program. All T-groups should be distributed as even as possible in one super-frame. This allows MPEG-2 decoders to effectively buffer the T-stream information and not to experience any buffer underflow or overflow.

In one super-frame, all groups for the same H-program should not be separated by any T-groups. T-groups can be separated by the H-groups belonged to the same or different H-programs. For example, if there is a T-program and four H-program that need to be broadcasted. T-program needs 30 groups. Each H-program needs 5 groups. T-program is on 64QAM rate=0.6, and H-program is on QPSK r=0.4. PN945 is used. If all H-programs are transmitted at every super-frame, a suggested group allocation is that Group 6 to 10 is for H1-program, Group 17 to 21 is for H2-program, Group 28 to 32 is for H3-program and Group 39 to 43 is for H4-program; all the rest are for T-program. When a group is allocated to a given H-program, if there are not enough DMB_H packets for this group, some null packets can be inserted. In another word, the PID of packets in the groups for H programs can be either 0×18 or 0×1fff. The TDS-OFDM-TH communications system has a few advantages including TDS-OFDM-TH can transmit two streams within one spectrum. The two streams are orthogonal in the same domain. The two streams can be encoded and modulated differently.

The TDS-OFDM-TH communications system further has power saving advantages in that a receiver may shut itself out at least partially if it is determined via the control frame that no packet was transmitted at the specific time. In other words, based upon the control information and the predetermined protocols defined above, when a receiver only needs to decode a particular H-program, the receiver only needs to be turned on during the period when that particular H-program is transmitted. The on/off control process is completed in the physical layer. This is unlike the known DVB-H solution, which needs to decode the received packets first and then decide when to turn on for the next time slot.

It is noted that the present invention contemplates using the PN sequence disclosed in U.S. Pat. No. 7,072,289 to Yang et al which is hereby incorporated herein by reference.

A method and system for an OFDM (Orthogonal frequency-division multiplexing) communication system is provided. The system and method include at least two programs being simultaneously transmitted under one spectrum. Each program is respectively modulated under a different or similar scheme. Each of the at least two programs commonly share a control frame. The control frame is transmitted under a similar or more robust modulation scheme than the at least two programs' modulations respectively.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An OFDM (Orthogonal frequency-division multiplexing) communication system comprising:
at least two programs being simultaneously transmitted under one spectrum with each program being respectively modulated under a different or similar scheme; and
each of the at least two programs commonly sharing a control frame with the control frame transmitted under a similar or more robust modulation scheme than the at least two programs' modulations respectively.

2. The communication system of claim 1, wherein the control frame is the first transmitted frame.

3. The communication system of claim 1, wherein when the at least two programs comprise a plurality of IP streams and at least one T-stream, the IP streams are first encapsulated and then multiplexed with the at least one T-stream.

4. The communication system of claim 1, wherein when the at least two programs comprise DVB streams with multiple programs and at least one T-stream, the DVB streams are first de-sliced and de-multiplexed before being multiplexed with the at least one T-stream.

5. The communication system of claim 1, wherein when the at least two programs comprise a plurality of IP streams and a plurality of DVB compatible streams, and at least one T-stream, the IP streams are first encapsulated and the DVB streams are first de-sliced and de-multiplexed with the resultant signals being multiplexed with the at least one T-stream.

6. The communication system of claim 1, wherein the control frame provides information relating a power saving to a receiver.

7. The communication system of claim 1, wherein the same or relatively lowest FEC rate as compared with a T-stream, an IP stream, or a DVB stream.

8. The communication system of claim 7, wherein the same or relatively lowest FEC rate comprises FEC 0.4.

9. In an OFDM (Orthogonal frequency-division multiplexing) communication system, a method comprising the steps of:
providing at least two programs being simultaneously transmitted under one spectrum with each program being respectively modulated under a different or similar scheme; and
for each of the at least two programs, sharing commonly a control frame with the control frame transmitted under a similar or more robust modulation scheme than the at least two programs' modulations respectively.

10. The method of claim 9, wherein the control frame is the first transmitted frame.

11. The communication system of claim 9, wherein when the at least two programs comprise a plurality of IP streams and at least one T-stream, the IP streams are first encapsulated and then multiplexed with the at least one T-stream.

12. The method of claim 9, wherein when the at least two programs comprise DVB streams with multiple programs and at least one T-stream, the DVB streams are first de-sliced and de-multiplexed before being multiplexed with the at least one T-stream.

13. The method of claim 9, wherein when the at least two programs comprise a plurality of IP streams and a plurality of DVB compatible streams, and at least one T-stream, the IP streams are first encapsulated and the DVB streams are first de-sliced and de-multiplexed with the resultant signals being multiplexed with the at least one T-stream.

14. The method of claim 9, wherein the control frame provides information relating a power saving to a receiver.

15. The method of claim 9, wherein the same or relatively lowest FEC rate as compared with a T-stream, an IP stream, or a DVB stream.

16. The method of claim 15, wherein the same or relatively lowest FEC rate comprises FEC 0.4.
